(19) United States
(12) Patent Application Publication
(10) Pub. No.: US 2025/0354036 A1
(43) Pub. Date: Nov. 20, 2025

(54) STAINABLE FINISH FOIL COMPOSITIONS AND METHODS OF MANUFACTURE

(71) Applicant: PRESSING DEVELOPMENTS, L.L.C., Georgetown, TX (US)

(72) Inventor: Adam Curtis Fuhr, Georgetown, TX (US)

(21) Appl. No.: 18/872,719

(22) PCT Filed: Jun. 7, 2023
(86) PCT No.: PCT/US2023/068082

§ 371 Date: Dec. 6, 2024

Related U.S. Application Data
(60) Provisional application No. 63/349,727, filed on Jun. 7, 2022.

(51) Int. Cl. C09J 127/06; C09J 7/35; C09J 9/00; C09J 11/04; C09J 125/10; C09J 167/03

(52) U.S. Cl. CPC C09J 127/06; C09J 7/35; C09J 9/00; C09J 11/04; C09J 125/10; C09J 167/03

(57) ABSTRACT

The present disclosure describes a stainable finish foil, and methods of preparing a stainable finish foil, with a two-layer top coating to provide a “multi-dimensional” staining effect that more-closely mimics the grain appearance of solid wood veneer or solid wood. When designed for use with water-based stains, the top coating typically includes wetting agents to provide a contact angle of 90° or less.

### CROSS-REFERENCE TO RELATED APPLICATIONS

This application claims the benefit of U.S. Provisional Application No. 63/349,727, entitled “STAINABLE FINISH FOIL COMPOSITIONS AND METHODS OF MANUFACTURE” which was filed Jun. 7, 2022, the entire disclosure of which is hereby incorporated herein by this reference.

### TECHNICAL FIELD

This disclosure relates to stainable finish foil, material and products, and improved methods of manufacturing stainable finish foil material and products with a more-realistic wood grain. The methods disclosed herein provide a formable sheet capable of being stained, including with typical absorbing stains, pigmented sealers, or clear sealers, producing a grain layer that more closely mimics natural wood products.

### BACKGROUND

Finish foil is an inexpensive alternative to wood. In general, finish foil, like thermofoil, is a plastic, vinyl, polyethylene terephthalate (PET), or paper substrate that has been printed with either wood grain or a synthetic wood grain print. Finish foil is in high production throughout the world because it simulates wood but uses resource alternative to hardwood.

These terms—finish foil and thermofoil-refer to similar concepts but are often defined in different ways, and sometimes even interchangeably to one degree or another. We use them here to refer to different compositions and methods for adhering the “foil” sheet (often a paper sheet) to the underlying structure. Thermofoil is formed around a surface and/or bonded to the surface using heat and pressure applied to the thermofoil. The heat and pressure expand the thermofoil during the process, resulting in a tight, form fit to the variations in the surface. The film of a thermofoil actually expands during the pressing/application process, and “sets” once the heat is removed. A thermofoil typically is a plastic, pvc, or other non-pvc film product. Conceptually, a thermofoil process is somewhat similar to a shrink wrap application except that a thermofoil typically expands during the application process, to form fit to the surface.

In contrast, a finish foil process simply adheres the finish foil to the surface, without the same degree of form fitting, using glue or some other adhesive. Each of these two processes has its own pros and cons. Thermofoil might be applied, for example, to a completed, fully-constructed cabinet door, while finish foil might be applied to the parts of the cabinet door before they are put together to form the completed cabinet door. Either way, the thermofoil or finish foil product is typically water resistant, easy to clean, and non-porous.

Finish foil, also known as décor paper, is usually a printed paper or plastic product that is or may be glued down to the desired surface, without use of heat to expand and fit the foil to the surface. The gluing process for finish foil can be a cold gluing process or a hot gluing process, but the foil itself is not intentionally heated for expansion and setting to form fit to the underlying substrate, even in a hot gluing process. Instead, any heat applied is only intended to heat the glue, to liquify and spread the glue for even distribution and even adhesion to the surfaces. In fact, heating the finish foil material to the same degree as in a thermofoil application typically would ruin the finish of the finish foil, warping the pattern layers and surface appearance of the foil.

Conventionally, finish foils may be produced, for example, by starting with a continuous sheet of paper, which sheet is then wound onto a roll for secondary processing. Once the sheet is rolled, the roll is loaded onto a machine to unroll to print layers of the desired pattern or grain on the paper. Ink is applied through, for example, rotogravure printing using UV-cured, solvent-based, or water-based inks, or through a high-speed digital printing using UV, EB or LED-cured inks. After the substrate has been printed with layers of the desired wood grain or synthetic wood grain print, the product is then coated with one or more UV-cured topcoats for final properties to finalize the finish foil product, which may be adhered to a structural substrate, or it may be sold “as is,” ready for the end user to adhere it to a structural substrate.

Once the foil has all of the layers completed, the product can be embossed for an enhanced grain texture, or simply re-wound onto a roll and cut to size per customer specifications. The resulting product simulates wood and can be prepared with various sheens and ranges in durability. The final products include edge banging, wrapped moldings, furniture components, cabinet components, or completed cabinet doors through various gluing processes. Typically, the product surface is sealed, and intended to be used “as is” by the end user, and not further stained or painted. Instead, the surface is sealed, easy to clean, and durable.

While the existing processes provide some flexibility for the customer, the minimum orders for custom products or colors typically are very large in order to be economically efficient. Also, the global production quality of finish foil products is inconsistent. Notably, finish foil products are typically sealed, and not easily stainable by the end user. Instead, they are intended to be used “as is” by the end user.

Accordingly, there is a need for manufacturing finish foil products that have a wood grain pattern but are still capable of being stained any color by the purchaser or end user, for example, with absorbing stains, pigmented sealers or clear sealers. The end user may then finish the product with a professional, high-quality coating to provide a much better look and increased durability and consistency of the overall surface. There is also a need for finish foil products, and a method of manufacturing them, with a higher definition “multi-dimensional” staining effect or appearance that more-closely mimics the appearance and treatment—the depth of the grain—of solid wood veneer or solid wood. The products and methods disclosed herein would reduce manufacturing and consumer costs and provide greater flexibility for the consumer while providing a more realistic product that can readily be finished by the customer to their own satisfaction.

### BRIEF SUMMARY

This disclosure relates in part to an improved stainable finish foil, e.g., a finish foil sheet that better mimics the depth of the appearance and grain of solid wood veneer or solid wood, and that allows the end user to stain the finish whatever color(s) they desire before sealing the surface. The stainable finish foil result comprises: a finish foil sheet which is the base layer, typically paper and itself potentially printed with a pattern; and at least two stainable topcoat layers affixed one by one on top of the finish foil sheet, wherein a dimensional effect is created by including at least 2 layers of stainable coating.

The finish foil sheet is the base layer, typically comprising a paper sheet to be coated with stainable layers that may be printed with a desired pattern, typically mimicking wood grain. The printing is applied directly to that paper sheet base layer. Multiple layers of print help provide further depth to the pattern being created on the paper, both in appearance and in actual physical depth providing a grainy feel to the touch. The base layer typically is paper, but may instead be a PVC, ABS, or PET sheet, or other appropriate material.

The ink used to print on the base layer is typically made from a resin system and pigments to simply provide the desired color. The way the ink bonds to the base layer is determined based on the resin used as a binder in the ink formulation.

In nonlimiting embodiments, the finish foil sheet is a paper sheet, a polyvinyl chloride (PVC) sheet, an acrylonitrile butadiene styrene (ABS) sheet, or a polyethylene terephthalate (PET) sheet, with at least two stainable layers applied to create a defined grain pattern, and one or more pearlescent or metallic layers applied beneath and/or between the stainable layers.

The stainable first layer applied to the paper base layer generally comprises a resin binder formulation comprising resins, an additive, and a porosity agent, before curing. This layer is applied all over, fully covering the printed paper base layer. The stainable first layer preferably includes a higher amount of very soft minerals, such as calcium carbonate and talc, and a pigment volume concentration above 35%. This type of coating, applied over the entire surface of the paper, allows for greater porosity, so that a larger volume of stain can be absorbed into the whole surface, acting as the base layer for the subsequent, second staining layer.

The second stainable layer creates a “grain layer” that further mimics the mineral streak portions that occur naturally in wood. The second staining layer again is applied in the desired pattern to mimic the mineral streak graining printed on the base paper image—not completely covering the entire sheet. This grain layer also contains a high concentration of minerals but using a different blend of components to provide a better distinction from the first layer—for example, the second staining layer may include calcium carbonate, kaolin clay, and at least 40% pigment volume concentration in order to create a more-defined grain pattern.

The composition may include one or more layers with a clear ink made from resin and water that has pearlescent or metallic flake mixed in to provide a shimmer effect. When placed in layers of various patterns, often a print layer alternating with a pearlescent layer, this provides the wood grain print with an iridescence that, when finished, looks like movement in the pattern, helping to replicate what naturally happens in hardwood when it is cut in certain grain directions, providing a natural iridescence when finished. Depending on the desired appearance, such as the species of wood sought to be mimicked, the pearlescent or metallic flake may be applied over the entire surface, or in a pattern covering only parts of the underlying material.

Sometimes multiple layers of the semitransparent pearl essence or metallic layer are positioned between ink layers, preceding the first and second stainable topcoat layers. In certain embodiments, adding an overall layer of pearl or metallic semitransparent ink, then applying a layer of ink in a grain pattern, then applying an additional layer of pearl or metallic ink printed as a grain pattern, then applying 2 layers of stainable topcoat, allows for the multi-dimensional effect.

The semitransparent pearlescent or metallic layer(s) may be applied before each stainable layer on the paper. For example, the composition may include a first paper layer that typically is a complete layer; the second layer may be a pearlescent or metallic layer substantially covering the first layer; the third layer may be a pattern layer including resin and pigment, typically applied as a pattern and not a complete covering; the fourth layer may be another pearlescent or metallic layer substantially covering the composition; the fifth layer may be an overall clear layer covering the composition and including porosity agents; the sixth layer may again be a pattern layer applied as a pattern and not a complete covering.

The completed composition would then be affixed, such as by gluing, to the desired structure, typically wood, plastic, vinyl, PET, or the like, providing a more realistic wood-like appearance, ready to be stained like a real wood or real wood veneer product. The finish foil product appearance here generally is designed to greatly mimic the appearance of real wood, including the ability to stain the product as one may do with a real wood or real wood veneer product.

Very often, the finish foil sheet is a polyvinyl chloride (PVC) sheet, an acrylonitrile butadiene styrene (ABS) sheet, a polyethylene terephthalate (PET) sheet, or a paper sheet, with two stainable layers applied to create a defined grain pattern, and one or more pearlescent or metallic layers applied beneath or between the stainable layers.

### BRIEF DESCRIPTION OF THE DRAWINGS

Implementations will hereinafter be described in conjunction with the appended drawings, where like designations denote like elements.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations.

FIGS. 1-2 depict non-limiting exemplary perspective views of stainable finish foil products having one stainable topcoat layer.

FIGS. 3-4 depict non-limiting exemplary perspective views of stainable finish foil products having two stainable topcoat layers.

FIGS. 5-6 depict non-limiting exemplary cross-sectional views of stainable finish foil products having one stainable topcoat layer.

FIGS. 7-8 depict non-limiting exemplary cross-sectional views of stainable finish foil products having two stainable topcoat layers.

FIGS. 9-10 depict example processes of manufacturing a stainable finish foil product. Optional steps of the process are indicated.

FIG. 11 depicts an example pointing out an area of mineral streak/grain, compared to an area of general overall grain.

FIGS. 12A and 12B depict prior art explanation of the relationship between contact angle and substrate wetting.

### DETAILED DESCRIPTION

### Definitions

The verb “comprise” as is used in this description and the claims and its conjugations are used in its non-limiting sense to mean that items following the word are included, but items not specifically mentioned are not excluded.

Reference to an element by the indefinite article “a” or “an” does not exclude the possibility that more than one of the elements are present unless the context clearly requires that there is one and only one of the elements. The indefinite article “a” or “an” thus usually means “at least one.” For example, “a” or “the” porosity agent refers to one porosity agent or a combination of porosity agents.

As used herein, the term “about” refers to plus or minus a tolerance that is 20% of the value (e.g., “about 1” refers to 0.8-1.2, and “about 5” refers 4-6).

As used herein, the term “finish foil” or “décor paper” refers to a plastic or paper material which is capable of being affixed to the profile of an underlying substrate (e.g., an engineered wood core such as medium-density fiberboard) using glue, to produce a surface finish. Fixation may be, for nonlimiting example, by applying glue to bond the sheet to the substrate.

As used herein, a “stainable finish foil” is an improved finish foil with added layer or layers on top of the base layer to provide a surface with absorption characteristics that allow a pigment or dye to penetrate, creating a “stain” effect. Stainable finish foil products are designed to allow the end user to stain the product while maintaining any printed grain in the finish. In contrast, traditional finish foil did not include stainable surface layers, and are typically not designed or intended to be stainable, instead selling as a finished product for use “as is” by the end user.

As used herein, the term “Thermofoil” refers to a plastic or paper material which is capable of being thermoformed, or affixed with heat and pressure, to the profile of an underlying substrate (e.g., an engineered wood core such as medium-density fiberboard) to produce a surface finish.

As used herein, the term “stainable” refers to an ability of the surface of a material to have absorption characteristics that allow a pigment or dye to penetrate which creates a “stain” effect.

As used herein, the term “absorbing stains” refers to a colorant, e.g., one or more dyes and/or pigments, suspended or dissolved in an agent or solvent. Non-limiting examples include an oil stain, varnish stain, water-based stain, solvent-based stain, gel stain, lacquer stain, water-soluble dye stain, ultra-violet (UV) light cured colorant, and metal or complex (metalized) dye stain, etc. Non-limiting examples of UV-cured colorant include sealants (e.g., pigmented sealers), stains, etc. Similar stains or colorants now existing or yet to be discovered may also be used.

As used herein, the term “ink” refers to an ink useful for printing on the base layer. Such inks are typically made from a resin system and pigments to simply provide the desired color. The way the ink bonds to the base layer depends on the resin used as a binder in the ink formulation. Inks may be applied, for non-limiting example, using a rotogravure printing apparatus, or using a high-speed digital printing apparatus. Rotogravure inks may be, for example, UV-cured inks, solvent-based inks, water-based inks, or natural based inks. See, for example, https://www.mxinternational.com/products/inks-and-coatings/process/gravure. High speed digital printing inks may be, for example, UV-cured inks, EB-cured inks, or LED-cured inks.

As used herein, the term “resin” refers to a solid or highly viscous substance of plant or synthetic origin that is typically convertible into polymers.

As used herein, the term “topcoat” or “topcoat layer” refers to a layer of resins and compositions overlaying an interior layer of a finish foil material. The topcoat is used to give a uniform, smooth or textured, durable, aesthetically appealing, and stainable finish.

As used herein, the term “pigment volume concentration” refers to the volume percentage of solid particles in the system after film formation. The calculation is as follows: the volume of the porosity agent divided by the volume of the porosity agent plus the resin volume solids. “Pigment volume concentration” determines if there is enough mineral in the resin system to actually realize the absorbency of the minerals in the final surface.

As used herein, the term “additive” refers to compounds that make the product flow, level, dilute, reduce, react, and/or defoam, e.g., a deaerator, a dispersant, a catalyst, a photoinitiator, a wetting agent, etc. Accordingly, additives include surface modifiers, curing agents, and the like.

As used herein, the term “photoinitiator” refers to a compound that can transform the physical energy of light into suitable chemical energy in the form of reactive intermediates. On absorption of light, a photoinitiator undergoes a photoreaction and produces reactive species which initiate or catalyze chemical reactions that result in significant changes in the solubility and physical properties of suitable formulations.

The present disclosure relates to the discovery that certain porosity-promoting surface agents included in a formulation of a resin binder (e.g., epoxy acrylates or acrylics) applied to a finish foil sheet result in the resin binder treated finish foil sheet having a porous surface that is capable of absorbing stains, pigmented sealers, or clear sealers after being manufactured. The absorption of the stainable topcoat layer(s) can be controlled by the process of adding finely ground minerals in high concentrations into the stainable (e.g., UV-cured or air-cured) coating of each layer. By allowing the base design and pattern of the resulting surface of the finish foil to absorb stains, pigments, or clear sealers after the finish foil is adhered to a cabinet door or component, for example, the present disclosure provides finish foil with much more flexibility and end product control by the customer, in a product with a significantly higher quality appearance more similar to that of a real wood or real wood veneer product. Additional benefits include reduced cost and greatly increased water resistance compared to the real wood or real wood veneer counterpart.

In a first aspect of the present disclosure, there is provided a stainable finish foil comprising a finish foil sheet or base sheet, and at least one stainable topcoat layer affixed to the finish foil sheet, wherein the stainable topcoat layer comprises a resin binder formulation comprising resins, an additive, and at least 35 weight percent of a porosity agent, before curing.

In a second aspect of the present disclosure, there is provided a method of manufacturing a stainable finish foil, comprising applying to the finish foil sheet at least one stainable topcoat layer comprising a resin binder formulation comprising resins, an additive, and at least 35 weight percent of a porosity agent, before curing.

In certain aspects, the stainable topcoat layer is pliable and wrapable and allows varying surface effects for staining.

In a further aspect of the present disclosure, at least two coating layers are applied to the finish foil sheet, to achieve a “multi-dimensional” staining effect that more closely mimics the grain of solid wood veneer or solid wood.

A stainable topcoat layer is formed by adding at least one porosity agent 150 and at least one additive to a resin binder layer 120 before curing the resin binder layer 120. Existing formulations of energy-curable resins may be used in the present disclosure to create stainable resin binder layers 120 by adding porosity agents 150 as disclosed herein.

### The Finish Foil

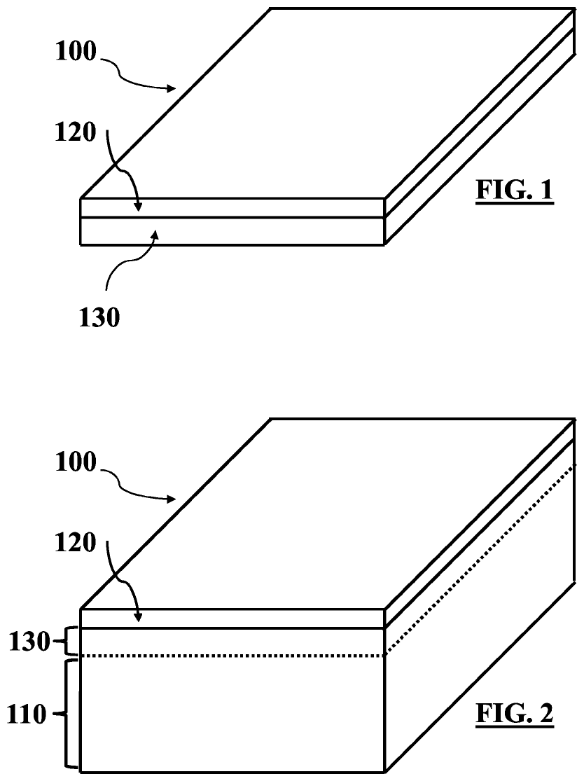

In some non-limiting embodiments, the finish foil sheet 130 (FIG. 1) is a polyvinyl chloride (PVC) sheet, an acrylonitrile butadiene styrene (ABS) sheet, a polyethylene terephthalate (PET) sheet, or a cellulose paper. In other embodiments, the finish foil sheet 130 (FIG. 1) is a polyvinyl chloride (PVC) sheet, an acrylonitrile butadiene styrene (ABS) sheet, or a polyethylene terephthalate (PET) sheet. In one implementation, the finish foil sheet 130 (FIG. 1) is a cellulose paper. In one aspect, the finish foil sheet 130 (FIG. 1) is a polyvinyl chloride (PVC) sheet. In another aspect, the finish foil sheet 130 (FIG. 1) is an acrylonitrile butadiene styrene (ABS) sheet. In another aspect, the finish foil sheet 130 (FIG. 1) is a polyethylene terephthalate (PET) sheet.

Finish foil sheets made of PVC, ABS or PET are not capable of being saturated with a resin system (e.g., urea-formaldehyde resins or melamine formaldehyde resins) due to several factors: 1) Chemical compatibility is not present; 2) The PVC, ABS and PET sheets are not capable of withstanding the amount of heat and pressure used to create a laminate surface; and 3) The melamine resin systems can be adapted to have short term adhesion to the surface of PVC, ABS or PET sheets, but the resin system will lose adhesion over time due to the large differences in their modulus of elongation (i.e., the amount the substrate (PVC, ABS or PET) moves versus the amount the coating (melamine resin system) moves over time and tension).

Impregnating a resin binder layer with the resin system functions differently than coating the finish foil sheet with a resin system. When a resin system saturates a paper sheet, excellent bonding to the substrate as well as uniform stainability result. Having the resin system on the surface as provided by the present invention allows varying surface effects for staining. In other words, applying the resin system topically allows for more creative patterns for staining that cannot be achieved through the impregnated process.

In certain non-limiting implementations, the finish foil sheet 130 is affixed onto an underlying substrate 110 (FIG. 2). Non-limiting examples of the substrates 110 include edge banging, wrapped moldings, furniture components, cabinet components, or completed cabinet doors, etc. In these implementations, no additional sealers or topcoats are applied to the finish foil sheet 130 before the application of the stainable topcoat layer 120.

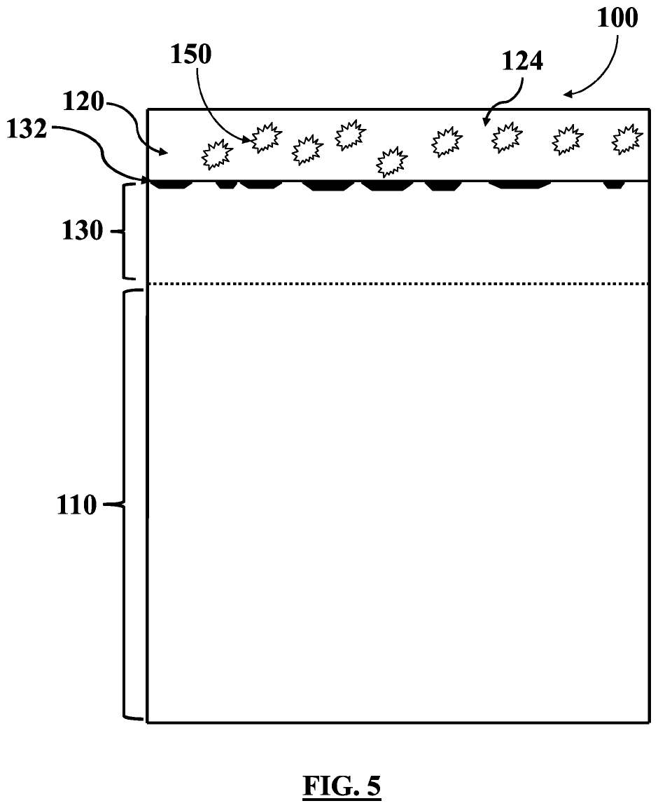

In non-limiting implementations of the first aspect, the stainable finish foil 100 comprises a wood grain design 132 (FIG. 5). In some embodiments, a base color layer can be applied to the entire surface. An initial grain pattern can be applied to a portion of the surface where the underlying overall color can be partially seen. Then a layer of pearl or other metallic layer that is semi-transparent can be applied over the entire surface. A layer of ink can be printed in a pattern of the grain while allowing the previous surfaces to remain visible. Another pearl or metallic layer can be printed in a grain pattern such that everything underneath can be seen. Then an overall layer of stainable coating that is transparent allowing everything underneath to be seen can be applied. Another layer of stainable coating can be printed in a grain pattern to create texture. Multi-dimensional staining can thus take place afterwards.

In non-limiting implementations of the second aspect, the method further comprises producing a wood grain print onto the finish foil sheet using an ink selected from the group consisting of: a solvent reduced ink, water reduced ink, and UV curable ink before applying the stainable topcoat layer. In some implementations, the method further comprising applying a seal coating between producing the wood grain print and applying the stainable topcoat layer.

### The Resin Binder Layers

In some non-limiting embodiments, each resin binder layer (total applied weight) is applied in an amount of between 5 and 190 grams per square meter (gsm) of the entire surface of the coating and ink layers on the finish foil sheet, or any number range in between, e.g., 5-175 gsm, 5-160 gsm, 5-145 gsm, 5-130 gsm, 5-115 gsm, 5-100 gsm, 5-85 gsm, 5-70 gsm, 10-190 gsm, 10-175 gsm, 10-160 gsm, 10-145 gsm, 10-130 gsm, 10-115 gsm, 10-100 gsm, 10-85 gsm, 10-70 gsm, 15-190 gsm, 15-175 gsm, 15-160 gsm, 15-145 gsm, 15-130 gsm, 15-115 gsm, 15-100 gsm, 15-85 gsm, 15-70 gsm, 20-190 gsm, 20-175 gsm, 20-160 gsm, 20-145 gsm, 20-130 gsm, 20-115 gsm, 20-100 gsm, 20-85 gsm, 20-70 gsm, 25-190 gsm. 25-175 gsm, 25-160 gsm, 25-145 gsm, 25-130 gsm, 25-115 gsm, 25-100 gsm, 25-85 gsm, and 25-70 gsm, etc.

### The Resins

In some non-limiting embodiments, the resins are energy-curable resins. Non-limiting examples of energy-curable resins include ultraviolet (UV)-curable resins, electron beam (EB)-curable resins, or conventional heat source-curable (non-UV/EB) resins, etc. In these embodiments, the resin binder formulation comprises a photoinitiator. In other embodiments, the resins cure over time even without application of an energy source, though they may cure at a slower rate without the added energy source.

In certain non-limiting embodiments, the resins require a catalyst to form a film (catalyzed system).

In other non-limiting embodiments, the resins form a film without the requirement of additional catalyzation (non-catalyzed system). In these embodiments, the resin binder formulation does not require a catalyst. In some non-limiting implementations, the non-catalyzed system forms a film through air drying due to a relatively low (e.g., lower than room temperature) glass transition temperature (Tg). In other non-limiting implementations, the non-catalyzed system uses solvents to decrease the Tg to allow the resin to form a film through evaporation.

In some non-limiting implementations, the energy-curable resins are selected from the group consisting of: urethane acrylates, polyester acrylates, epoxy acrylates, acrylics, and combinations thereof. In other non-limiting implementations, the energy-curable resins are selected from the group consisting of: epoxy acrylates, acrylics, and a combination thereof.

Epoxy acrylates are commercially available from manufacturers such as: Sartomer, BASF, or Miller-Stephenson, etc. Non-limiting examples of epoxy acrylates are described in greater detail, and hereby incorporated by reference in their entirety, in the following patents and references: U.S. Pat. Nos. 3,989,610; 4,472,019; 4,789,620; 5,086,088; 5,356,949; 6,844,034; EP U.S. Pat. No. 1,295,900; and Chattopadhyay et al., Thermal and mechanical properties of epoxy acrylate methacrylates UV cured coatings, Progress in Organic Coatings 54 (1), 2005; Habib et al., UV Curable Heat Resistant Epoxy Acrylate Coatings, Chemistry & Chemical Technology 4 (3), 2010; and Konuray et al., State of the Art in Dual-Curing Acrylate Systems, Polymers 10, 2018.

Acrylics are commercially available from manufacturers such as: Advanced Plastiform, Inc., etc. Non-limiting examples of acrylics are described in greater detail, and hereby incorporated by reference in their entirety, in the following patents: U.S. Pat. Nos. 5,242,968; 5,686,186; 7,252,786; China Patent No. 101044023; and Germany Patent No. DE 69725,422.

In some non-limiting implementations, before curing, the resin binder formulation comprises between 15 and 45 weight percent of the resins (e.g., epoxy acrylates or acrylics), or any percent range in between, e.g., 15-43%, 15-40%, 15-38%, 15-35%, 16-45%, 16-43%, 16-40%, 16-38%, 16-35%, 17-45%, 17-43%, 17-40%, 17-38%, 17-35%, 18-45%, 18-43%, 18-40%, 18-38%, 18-35%, 19-45%, 19-43%, 19-40%, 19-38%, 19-35%, 20-45%, 20-43%, 20-40%, 20-38%, or 20-35% of the resins, etc., as determined based on the resin solids in the liquid used.

In certain non-limiting implementations, after curing, the resin binder formulation comprises between 5 and 45 weight percent of the resins (e.g., epoxy acrylates or acrylics), or any percent range in between, e.g., 5-40%, 5-35%, 5-30%, 5-25%, 6-45%, 6-40%, 6-35%, 6-30%, 6-25%, 7-45%, 7-40%, 7-35%, 7-30%, 7-25%, 8-45%, 8-40%, 8-35%, 8-30%, 8-25%, 9-45%, 9-40%, 9-35%, 9-30%, 9-25%, 10-45%, 10-40%, 10-35%, 10-30%, or 10-25% of the resins, etc.

The resin binder portion of the applied weight is between 2 and 100 gsm per resin binder layer of the finish foil sheet, or any number range in between, e.g., 2-95 gsm, 2-90 gsm, 2-85 gsm, 2-80 gsm, 2-75 gsm, 2-70 gsm, 2-65 gsm, 2-60 gsm 2-55 gsm, and 2-50 gsm, etc.

In other non-limiting implementations, the resin binder formulation further comprises urea-formaldehyde resins, melamine formaldehyde resins, or both.

### The Porosity Agent

In some embodiments, the porosity agent comprises one or more minerals (e.g., two, three, four, etc.) to enable the finish foil sheet or product to be stained.

In non-limiting embodiments, the particle size of the porosity agent 150 typically ranges from 0.4 μm to 80 μm, or any other number range in between, e.g., 0.4-70 μm, 0.5-70 μm, 0.5-60 μm, 0.6-60 μm, 0.6-50 μm, 0.7-50 μm, 0.7-40 μm, 0.8-40 μm, 0.8-30 μm, 0.9-30 μm, 0.9-20 μm, 0.9-15 μm, 0.4-60 μm, 0.4-45 μm, 0.4-30 μm, or 0.4-15 μm.

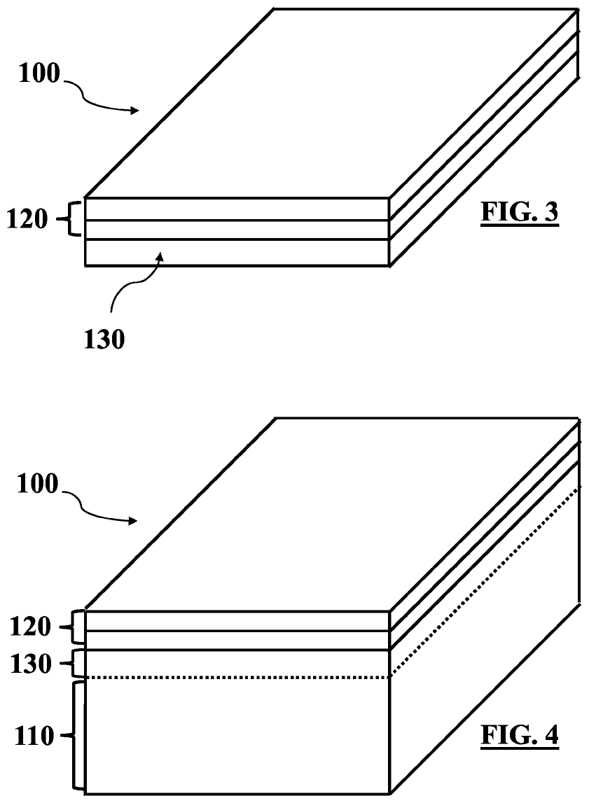

In non-limiting embodiments, the density of the porosity agents 150 (FIGS. 3-4) typically ranges from 0.5 g/cm³ to 4.5 g/cm³, or any other number range in between, e.g., 0.5-4.2 g/cm³, 0.6-4.2 g/cm³, 0.6-4.0 g/cm³, 0.7-4.0 g/cm³, 0.7-3.8 g/cm³, 0.8-3.8 g/cm³, 0.8-3.6 g/cm³, 0.9-3.6 g/cm³, 0.9-3.5 g/cm³, 1-3.5 g/cm³, 1-3.4 g/cm³, 1.1-3.4 g/cm³, 1.1-3.3 g/cm³, 1.1-3.2 g/cm³, 1.2-3.2 g/cm³, 1.4-3.2 g/cm³, 1.4-3.1 g/cm³, 1.6-3.1 g/cm³, 1.6-3.0 g/cm³, 1.8-3.0 g/cm³, or 1.8 to 2.9 g/cm³, etc.

Non-limiting examples of the porosity agents 150 include: calcium carbonate (e.g., precipitated calcium carbonate), crystalline silica (e.g., microcrystalline silica, silica, and silicate minerals), kaolin clay, talc; another mineral commonly used in the production of paint and coatings; another agent that result in a cured resin binder surface having porous characteristics that enable a stain to penetrate into the resin binder layer 120, or combinations thereof, etc. Silica includes untreated silica, treated silica, or both.

In some embodiments, at least one of the porosity agents 150 is selected from the group consisting of: calcium carbonate, kaolin clay, silica, and talc. In other embodiments, at least one of the porosity agents 150 is selected from the group consisting of: kaolin clay, silica, and talc. In yet other embodiments, the porosity agent 150 is selected from the group consisting of: kaolin clay and talc.

In other embodiments, the porosity agent 150 is calcium carbonate. In one aspect, the calcium carbonate is ground (natural) calcium carbonate (GCC). In another aspect, the particle size of the calcium carbonate is between about 0.5 μm and about 500 μm, between about 0.5 μm and about 400 μm, between about 0.5 μm and about 300 μm, between about 0.5 μm and about 200 μm, between about 0.5 μm and about 100 μm, between about 0.5 μm and about 90 μm, between about 0.5 μm and about 80 μm, between about 0.5 μm and about 70 μm, between about 0.5 μm and about 60 μm, between about 0.5 μm and about 50 μm, between about 0.5 μm and about 40 μm, between about 0.5 μm and about 30 μm, between about 0.5 μm and about 20 μm, or between about 0.5 μm and about 10 μm. In one aspect, the particle size of the calcium carbonate is between about 0.5 μm and about 100 μm. In another aspect, the particle size of the calcium carbonate is between about 0.5 μm and about 50 μm.

In one embodiment, the porosity agent 150 is not silica. In certain aspects, silica may have an adverse effect on the ability of the final surface to absorb stains.

In certain preferred implementations, the porosity agent 150 comprises kaolin clay, silica, and talc in the ratio of about 3 to 2 to 1 by weight (i.e., a formulation comprising 600 grams of mineral would comprise about 300 grams of kaolin clay, about 200 grams of silica, and about 100 grams of talc). In other preferred implementations, the porosity agent 150 comprises kaolin clay, silica, and talc in the ratio of about 2.5-3.5 to 1.5-2.5 to 1 by weight, or any ratio range in between, e.g., 2.6-3.4 to 1.6-2.4 to 1, 2.7-3.3 to 1.7-2.3 to 1, 2.8-3.2 to 1.8-2.2 to 1, 2.9-3.1 to 1.9-2.1 to 1, etc.

In non-limiting embodiments, the typical amount of the one or more porosity agents 150 per resin binder layer is at least 2 gsm of the finish foil sheet, e.g., at least 2.5 gsm, at least 3 gsm, at least 3.5 gsm, or at least 4 gsm of the finish foil sheet. In other non-limiting embodiments, the typical amount of the one or more porosity agents 150 per resin binder layer is between 2-100 grams per square meter (gsm) of the finish foil sheet, or any number range in between, for example, 3-70 gsm, 3-65 gsm, 3-60 gsm, 3-55 gsm, 3-50 gsm, 3-45 gsm, 3-40 gsm, 3-35 gsm, 3-30 gsm, 3-25 gsm, 3-20 gsm, 3.5-70 gsm, 3.5-65 gsm, 3.5-60 gsm, 3.5-55 gsm, 3.5-50 gsm, 3.5-45 gsm, 3.5-40 gsm, 3.5-35 gsm, 3.5-30 gsm, 3.5-25 gsm, 3.5-20 gsm, 4-70 gsm, 4-65 gsm, 4-60 gsm, 4-55 gsm, 4-50 gsm, 4-45 gsm, 4-40 gsm, 4-35 gsm, 4-30 gsm, 4-25 gsm, or 4-20 gsm, etc.

In non-limiting embodiments, the resin binder formulation 124 comprises at least 35 weight percent of the porosity agent, before curing, e.g., at least 40 weight percent, at least 45 weight percent, at least 50 weight percent, at least 55 weight percent, or at least 60 weight percent of the porosity agent, before curing.

In other non-limiting embodiments, the resin binder formulation 124 comprises between 30% and 70% of the porosity agent, before curing, or any percent range in between, e.g., 30% and 68%, 35-68%, 35-65%, 36-65%, 36-63%, 37-63%, 37-60%, 38-60%, or 40-60%, etc., before curing.

The pigment volume concentration is very important in the overall functionality of the system to become absorbent. In non-limiting embodiments, the pigment volume concentration is between 25%-80%, or any percent range in between, for example, 25%-70%, 25%-65%, 25%-60%, 25%-55%, 30%-80%, 30%-75%, 30%-70%, 30%-65%, 30%-60%, 30%-55%, 35%-80%, 35%-75%, 35%-70%, 35%-65%, 35%-60%, 35%-55%, 40%-80%, 40%-75%, 40%-70%, 40%-65%, 40%-60%, 45%-80%, 45%-75%, 45%-70%, 48%-80%, 48%-75%, or 48%-70%, etc.

### The Additive

In some embodiments, the resin binder further comprises an additive, wherein at least one additive is selected from the group consisting of: a deaerator, a dispersant, a wetting agent, a photoinitiator, a catalyst, and combinations thereof. In order for the stainable coating to be universally compatible with both solvent-based and water-based stains, the wetting agent is critical for altering the contact angle of the stainable coating, thereby facilitating absorption of a water-based stain. The wetting agent is not needed for use with solvent-based stains.

In some implementations, before curing, the resin binder formulation comprises between 0.01 and 1 weight percent of the deaerator, or any percent range in between, for example, 0.01 and 0.9 weight percent, 0.01-0.8 weight percent, 0.01-0.7 weight percent, 0.01-0.6 weight percent, 0.01-0.5 weight percent, 0.015 and 1 weight percent, 0.015 and 0.9 weight percent, 0.015-0.8 weight percent, 0.015-0.7 weight percent, 0.015-0.6 weight percent, 0.015-0.5 weight percent, 0.02-1 weight percent, 0.02 and 0.9 weight percent, 0.02-0.8 weight percent, 0.02-0.7 weight percent, 0.02-0.6 weight percent, or 0.02-0.5 weight percent of the deaerator, etc.

In some implementations, before curing, the resin binder formulation comprises between 0.01 and 1 weight percent of the dispersant, or any percent range in between, for example, 0.01 and 0.9 weight percent, 0.01-0.8 weight percent, 0.01-0.7 weight percent, 0.01-0.6 weight percent, 0.01-0.5 weight percent, 0.015 and 1 weight percent, 0.015 and 0.9 weight percent, 0.015-0.8 weight percent, 0.015-0.7 weight percent, 0.015-0.6 weight percent, 0.015-0.5 weight percent, 0.02-1 weight percent, 0.02 and 0.9 weight percent, 0.02-0.8 weight percent, 0.02-0.7 weight percent, 0.02-0.6 weight percent, or 0.02-0.5 weight percent of the dispersant, etc. Any suitable dispersant may be utilized.

In some implementations, the resins are ultraviolet (UV)-curable, electron beam (EB)-curable, or both, and the resin binder formulation comprises, before curing, between 0.4 and 5 weight percent of the photoinitiator, or any percent range in between, for example, 0.4-4.5 weight percent, 0.4-4 weight percent, 0.5-5 weight percent, 0.5-4.5 weight percent, 0.5-4 weight percent, 0.8-5 weight percent, 0.8-4.5 weight percent, 0.8-4 weight percent, 1-5 weight percent, 1-4.5 weight percent, 1-4 weight percent, 1.5-5 weight percent, 1.5-4.5 weight percent, 1.5-4 weight percent, 2-5 weight percent, 2-4.5 weight percent, or 2-4 weight percent of the photoinitiator, etc.

In other implementations, the resin binder formulation comprises, before curing, between 0.4 and 5 weight percent of the catalyst, or any percent range in between, for example, 0.4-4.5 weight percent, 0.4-4 weight percent, 0.5-5 weight percent, 0.5-4.5 weight percent, 0.5-4 weight percent, 0.8-5 weight percent, 0.8-4.5 weight percent, 0.8-4 weight percent, 1-5 weight percent, 1-4.5 weight percent, 1-4 weight percent, 1.5-5 weight percent, 1.5-4.5 weight percent, 1.5-4 weight percent, 2-5 weight percent. 2-4.5 weight percent, or 2-4 weight percent of the catalyst, etc. Any suitable catalyst may be utilized.

In some non-limiting embodiments, the resin binder layer is between 90-100% cured, or any percent range in between, e.g., 90-99%, 90-98%, 90-97%, 90-96%, 92-100%, 92-99%, 92-98%, 92-97%, 92-96%, 94-100%, 94-99%, 94-98%, 94-97%, 94-96%, 95-100%, 95-99%, 95-98%, 95-97%, 95-96%, 100% cured, etc.

In some non-limiting embodiments, more than one stainable topcoat layers are affixed to the finish foil sheet. In these embodiments, the first stainable topcoat layer is the top-most layer, and the amount of the porosity agents is higher in the first stainable topcoat layer than the second stainable topcoat layer. In some non-limiting implementations, a pattern is applied to the first stainable topcoat layer using a printing cylinder, thus creating the pattern on the final surface, and no pattern is applied to the second stainable topcoat layer.

In some non-limiting implementations, the resin binder formulation of the first stainable topcoat layer comprises about 50 weight percent of a porosity agent, before curing. In other non-limiting implementations, the resin binder formulation of the first stainable topcoat layer comprises 40-60 weight percent of a first porosity agent, before curing, or any percentage number in between, e.g., 41-59%, 42-58%, 43-57%, 44-56%, or 45-55%, etc.

In some non-limiting implementations, the resin binder formulation of the second stainable topcoat layer comprises 15-40 weight percent of a second porosity agent, before curing, or any percentage number in between, e.g., 15-35%, 15-30%, 15-25%, 20-40%, 20-35%, 20-30%, 25-40%, 25-35%, 25-30%, or 30-40%, etc.

Non-limiting examples of the first and/or the second porosity agents 150 include: calcium carbonate (e.g., precipitated calcium carbonate), crystalline silica (e.g., microcrystalline silica, silica, and silicate minerals), kaolin clay, talc; another mineral commonly used in the production of paint and coatings; another agent that result in a cured resin binder surface having porous characteristics that enable a stain to penetrate into the resin binder layer 120, or combinations thereof, etc. Silica includes untreated silica, treated silica, or both. Diatomaceous earth can also be used in the formulations. This agent can assist in the absorbing of many stain systems including water based sprayable stains.

In some embodiments, at least one of the first and/or the second porosity agent 150 is selected from the group consisting of: calcium carbonate, kaolin clay, silica, diatomaceous earth, and talc. In other embodiments, at least one of the first and/or the second porosity agent 150 is selected from the group consisting of: kaolin clay, silica, diatomaceous earth, and talc. In yet other embodiments, the first and/or the second porosity agent 150 is selected from the group consisting of: kaolin clay, diatomaceous earth, and talc.

In some non-limiting embodiments, a stain is applied to the stainable finish foil. In further non-limiting embodiments, one or more additional coatings are applied after the stain. Non-limiting examples of the additional coatings applied after the stain include resins, and clear sealers, etc. (When a sealer is applied over the stainable topcoat layer, the finish foil is no longer stainable.)

Creating an Appearance that More Closely Mimics Solid Wood Veneer or Solid Wood

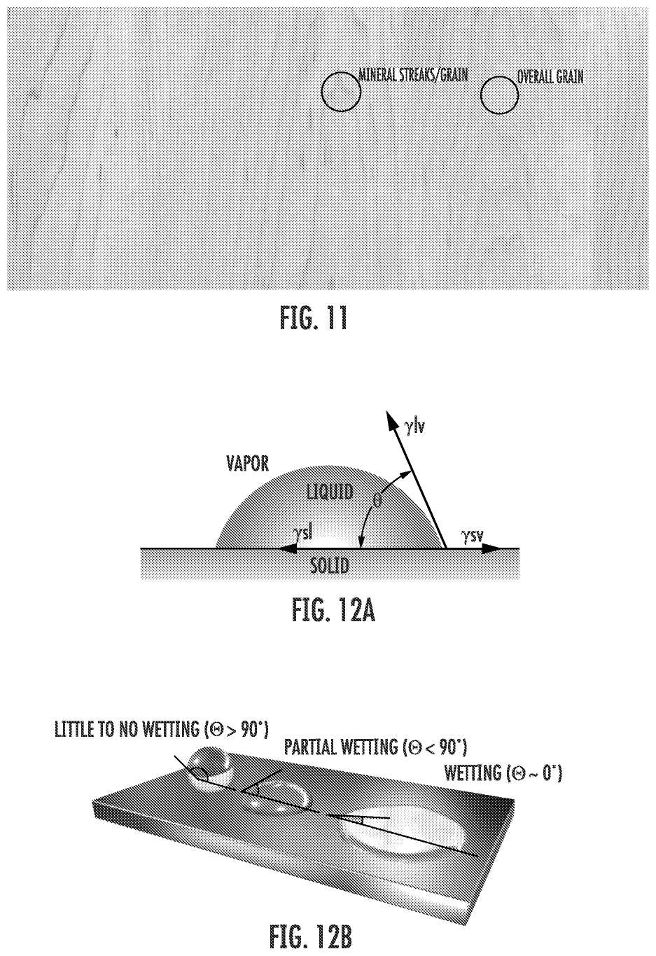

It was found that the loading of minerals (fillers) in each coating layer is very critical to achieve a “multi-dimensional” staining effect that truly mimics solid wood or solid wood veneer. Solid wood veneer has broad, open areas of wood that typically do not have patterns, but rather encompasses the larger overall structure of wood. In maple, for example, the broad, open portion is the portion that is lightest in color and makes up a majority of the wood surface (see FIG. 11).

The most absorption of a stain must take place in the more broad, open portions of the design. For this to happen, the first layer of coating must contain a higher amount of very soft minerals, such as calcium carbonate and talc. The loading was found to perform when the pigment volume concentrate is above 35%. This type of coating allows for a larger volume of stain to be absorbed into the whole surface thus acting on the surface as the base layer for staining.

For an improved dimensional effect, there typically must be at least 2 layers of coatings—a second layer must be added to the layer discussed above, creating a “grain layer” that mimics the mineral streak portions that naturally occur in wood. In maple, for example, these mineral streaks are the darker color thin lines making a pattern on the surface of the wood (see FIG. 11).

In order to reproduce this effect, we place a second layer of coating on the surface of the base layer. The second layer of coating should be in the pattern that is desired to mimic the mineral streak graining that has been printed on the base paper image that is being coated. This grain layer must also contain minerals in a high concentration, but the minerals should be slightly different in blend of components-simply placing a second layer of the same first coating over the base layer typically results in minimal distinction between grain layers. However, when changing the minerals in the second layer slightly as compared to the first layer, the distinction between layers became more apparent. A second layer mineral composition that includes calcium carbonate and kaolin clay, and above 40% Pigment Volume Concentrate can be utilized. This combination, for example, created more defined and distinguished grain patterns when stained.

Compared to a production run using only 1 layer—the base layer—of coating, the one-layer method provided easy production, and the overall product does absorb stain as well as clear coatings. For certain applications, this is a viable option, but for other uses it may not be viable. There is not a real distinction between grain layers when producing a commercial product with only 1 layer, but in lower cost industries this can be an option.

### Contact Angle Affects Stainability

One factor that plays a huge role in the universal stainability of these coatings on the surface of a finish foil product—including both solvent-based and water-based stains—is the contact angle of the coatings. The surface of wood absorbs stain because it is porous, but also, with water-based stains, because the contact angle of the stains and clear coatings touching the surface is less than 90 degrees. The lower the contact angle, the greater the wettability of the wood by a water-based stain.

The contact angle of maple, for example, is around 44 degrees, and the contact angle of pine is around 82 degrees. See, for example, Eliška Oberhofnerova, Miloš Panek, Surface Wetting of Selected Wood Species by Water During Initial Stages of Weathering, Wood Research, vol. 61(4), pp. 545-552 (2016). In order for the surface of the coated paper (or other printed substrate) to receive various stains, it must also be porous, and the contact angle must be at or below 90 degrees. In order to achieve this, the coatings must contain wetting agents, but these wetting agents must be in higher amounts based on the negative impact that minerals have on the contact angle, thus creating surface tension that interacts poorly with various stains (specifically water-based stains due to their inherently high surface tension). As discussed in the prior art, the contact angle affects the wettability of the wood by water-based stains and is an important factor regarding wood coatings. See https://coatings.specialchem.com/coatings-properties/surface-tension.

Specifically, the contact angle θ is the angle between the intersection of the liquid-solid interface and the liquid-vapor interface at the three-phase contact line. See FIG. 12A. This is an indication of the ability of the liquid to spread on the substrate. The solid/liquid (S/L) interfaces exhibit a different “surface tension” than the individual surfaces. The relationship between the S/L surface tensions can be derived from Young's Equation to determine the contact angle:

$$γ sv = γ sl + γ lv \cdot cos θ$$

where γsv represents the surface tension of solid; γlv represents the surface tension of the liquid; γsl represents the interfacial tension solid/liquid; and θ is the contact angle. See FIG. 12A.

When θ>90°, there is little to no wetting. When θ≤90°, there is partial wetting. When θ˜0°, there is spontaneous and complete wetting—i.e., the surface tension solid (γsv) is larger than the surface tension liquid (γsl). See FIG. 12B.

Therefore, substrate wetting depends primarily on the surface tension of the coating and on the surface tension of the substrate to be coated. To allow for proper wetting and adhesion between the layers, the surface tension of the coating must be lower than that of the substrate. By comparison, solvent borne systems typically have naturally low surface tensions and can easily wet most substrates, while water-based systems often have high surface tension resulting in poor wetting and require use of suitable raw materials or substrate treatment for effective substrate wetting.

In order to overcome inherent surface tension issues and surface interactions between water-based stains and the stainable finish foil sheet, we added a siloxane-based substrate wetting agent in the amount of 1% of the total weight of the formula. This amount can be increased to as much as 5%, if needed, but would not be less than 0.1%.

### Process Information

During processing, the stainable finish foil material can be dried through an oven system after the various layers have been added and/or at one or more intermediate points during the buildup of layers. Typically, though, the layers are sufficiently air drying through the construction process, with only a final drying step warranted. The dried stainable finish foil material can be rolled for storage prior to use. The product can be cut to the size that is needed for application to an assembled product, or to part of a product before the product is assembled. The application to a product or part of a product may be completed before sale by the manufacturer, or after sale by the end user.

In some embodiments, the base finish foil sheet paper is on a roll and is unwound and run through a gravure printing process using the following stages:
1. The paper is first treated with a roll coater applying a base color layer. This is the underlying color for a wood grain pattern.
2. Optionally, a layer of a semitransparent pearl essence is applied.
3. The paper is treated with an ink layer that is in a certain pattern associated with the wood grain it is to match.
4. Optionally, the paper is treated with an additional ink layer of a wood grain pattern to create more image fidelity and depth of image.
5. Optionally, the paper is treated with another additional ink layer of a wood grain pattern to create even more image fidelity and depth of image.
6. The paper is optionally treated with a layer of pearl essence in register with the grain pattern to accentuate the grain definition and depth of image.
7. The paper is treated with a base layer of stainable coating that is made from acrylic resin (for example) and includes surfactants, water, and one or more of the following minerals: calcium carbonate, talc, and diatomaceous earth.
8. The paper is then treated with an additional layer of stainable coating (same as above or slightly altered minerals) that creates an embossing effect. This means that this layer does not cover the entire surface, but rather leaves gaps to expose the layer beneath to allow for single layer and dual layer stain penetration.
9. The paper may then be dried through an oven system and re-rolled.
10. The finished product is a multi-dimensional stainable finish foil that has both multi-dimensional looks based on the pearl stages, but also multi-dimensional staining capabilities due to the layering system developed with the stainable coating layers. This final result is a very high-end product that can be glued or affixed to a substrate using various methods, such as gluing to flat panel components that are then assembled into the desired structure, serving as a direct replacement for a hardwood or hardwood veneer structure.

The present invention is further illustrated by the Figures and Claims that should not be construed as limiting. The contents of all references, patents, and published patent applications cited throughout this application, as well as the Figures, are incorporated herein by reference in their entirety for all purposes.

### EXAMPLES

FIGS. 1-4 depict non-limiting examples of the stainable finish foil product 100. The exemplary stainable finish foil product 100 comprises a finish foil sheet 130 and one or more stainable resin binder layer 120 applied to the surface of the finish foil sheet 130. In some non-limiting embodiments, there is one stainable resin binder layer 120 (FIGS. 1 and 2). In other non-limiting embodiments, there are two stainable resin binder layers (FIGS. 3 and 4). In FIGS. 2 and 4, the dotted line indicates that the finish foil sheet 130 is adhered to the substrate 110. In yet other non-limiting embodiments, there are more than two stainable resin binder layers (not shown).

In some non-limiting embodiments, the stainable finish foil product 100 further comprises a substrate 110 (FIGS. 2 and 4). The stainable finish foil 100 is affixed onto the substrate 110 via, for example, cold glue or heat melting glue. In numerous non-limiting embodiments, the base finish foil sheet 130 is a polyvinyl chloride (PVC) sheet, an acrylonitrile butadiene styrene (ABS) sheet, a polyethylene terephthalate (PET) sheet, or a cellulose paper.

Prior to Applicant's disclosure, the “complete” finish foil products available on the market were typically intended to be finished products, not designed or able to retain staining and/or further application of clear finish. These new stainable finish foil products, however, have open and porous surfaces capable of retaining stain and/or clear finish. Without limitation to any particular theory, applying a resin binder layer 120 comprising minerals and additives to the finish foil during the production process creates open and porous surfaces. Additionally, the porous surfaces physically harden, allowing the final layer to be sanded without impacting the underlying print pattern.

The adhesion of the finish foil sheet 130 to the substrate 110 is based on glue that is applied to the back of the foil or by applying glue to both the back of the foil and the substrate. The glue may be a hot glue applied, to facilitate spreading the glue, or it may be a cold glue application. Even if a hot glue application is used, the heat is simply to liquify and spread the glue, and not to affect the finish foil sheet itself. Applying substantial heat to the finish foil will often ruin the finish and warp the patterns in the finish foil.

Following application of the resin binder layer containing minerals to the surface of the finish foil, the foil can be glued to the surfaces of the substrate, typically parts of a product such as parts of a cabinet or cabinet door that are then assembled after the finish foil is applied. A finish foil application to a substrate, typically by gluing the finish foil to the substrate, is not as amenable as a thermofoil to forming closely around contoured surfaces, or closely and tightly wrapping around surfaces that have been previously formed through molding and cutting. Accordingly, the stainable finish foil sheet typically is applied to parts of the final structure before the structure is assembled, rather than to the fully-assembled structure.

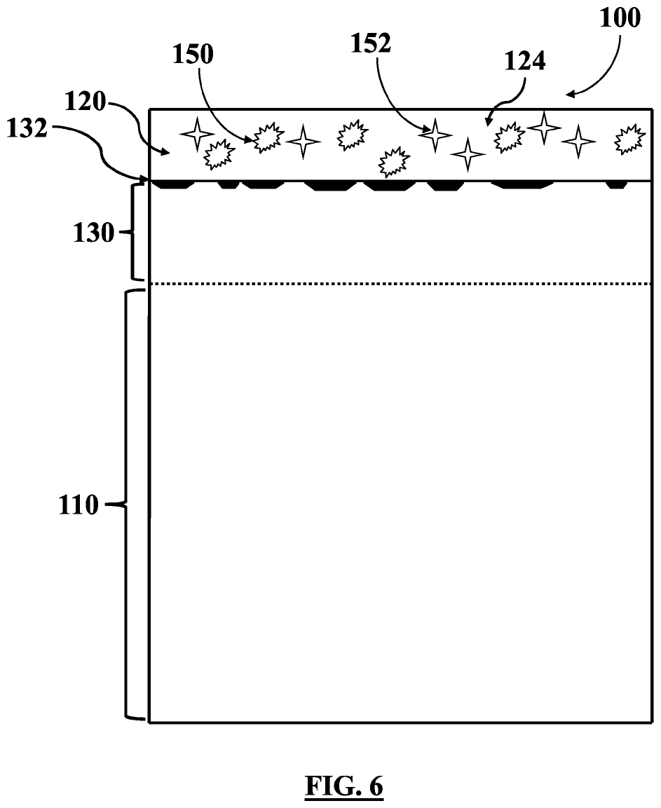

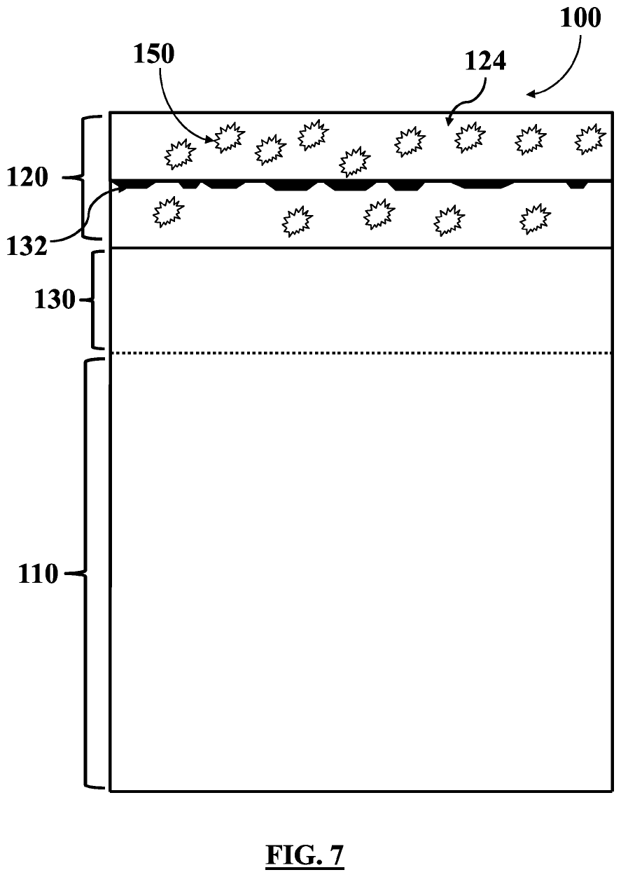

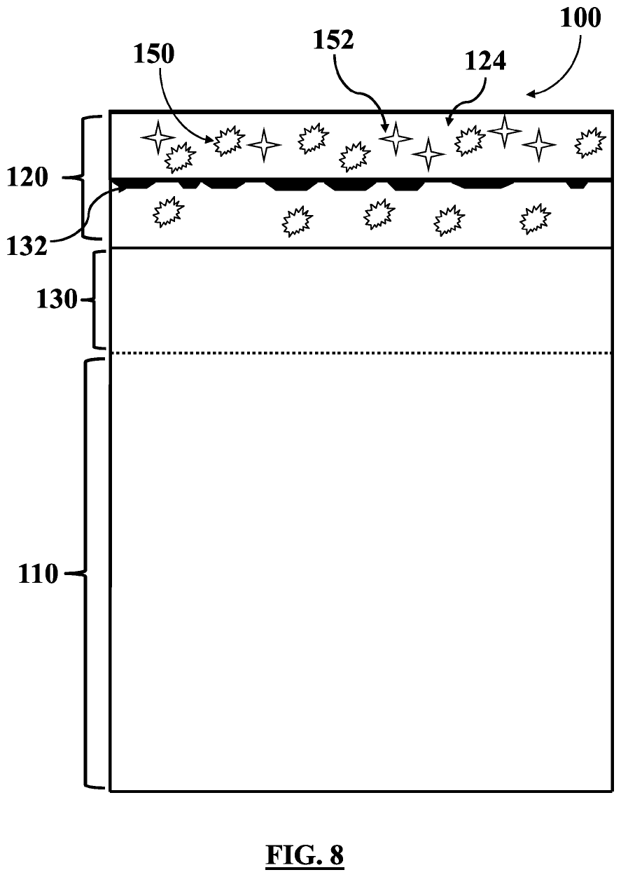

FIGS. 5-8 depict non-limiting examples of the stainable resin binder layer 120. In some non-limiting embodiments, the stainable resin binder layer 120 includes only one porosity agent 150 (see FIGS. 5 and 7). In other non-limiting embodiments, the stainable resin binder layer 120 includes two porosity agents 150 and 152 (see FIG. 6, and the outermost resin binder layer of FIG. 8). In further non-limiting embodiments, the stainable resin binder layer 120 includes more than two porosity agents 150 (not shown). In some non-limiting embodiments, the resin binder layer 120 is the final, topmost layer. In other non-limiting embodiments, more than one resin binder layer 120 is included.

In some embodiments, the stainable finish foil product 100 includes a stainable resin binder layer 120, and the stainable resin binder layer 120 is formed by applying to the surface of the finish foil sheet 130 an energy curable resin 124 that contains at least one porosity agent 150. See FIG. 5-8.

The stainable topcoat layer 120 comprises sufficient porosity agent 150 to allow for the absorption of both the energy curable resin 124, and later the subsequent stain that may be applied by the end user. The foil finish sheet 130 is a polyvinyl chloride (PVC) sheet, an acrylonitrile butadiene styrene (ABS) sheet, a polyethylene terephthalate (PET) sheet, or a cellulose paper. Due to their chemical nature, PVC, PET, and ABS sheets do not absorb the stain without first being treated to alter the surface so that it can absorb stain. While cellulose paper absorbs stain, it does not absorb evenly, causing the printed image on the surface of the paper to be distorted.

Without limitation, when one or more porosity agents 150 (mineral additives) is added to the point of achieving very close to the Critical Pigment Volume Concentrate, the one or more porosity agents 150 will not be fully saturated by the resin. Consequently, after the stainable resin binder layer 120 is applied, the surface will have exposed/uncoated minerals accessible allowing stains to wet out and absorb into the minerals and coating. Because the amount and location of the absorption can be controlled by applying a stainable topcoat layer 120 comprising high-volume porosity agents 150 (e.g., based on printing one of the stainable topcoats), highly repeatable, yet realistic substrate can be created for the industry to use in mass production.

In some non-limiting implementations, a sealer that does not contain a porosity agent is applied below the stainable topcoat layer. As a result, the substrate would be sealed, and a stain would not be able to reach past the sealer to the finish foil sheet 130. In further non-limiting implementations, the stainable topcoat layer 120 is printed as a pattern onto the finish foil sheet 130.

The porosity agents 150 can contribute to creating a stainable finish foil product 100 in a number of different ways. The porosity agents 150 distributed throughout the resin binder layer 120 provide a path for a stain to seep into and ultimately reach the sheet 130, where the sheet 130 then soaks in, distributes, and holds the stain. Additionally, the porosity agents 150 themselves can soak in stain and help add more of the stain color throughout the resin binder layer 120. Experiments have shown that deep and even stain penetration often occurs when the pigment volume concentration of the porosity agent(s) 150 to the energy curable resin 124 reaches or exceeds the critical pigment volume concentration of the energy curable resin 124. The critical pigment volume concentration of the thermosetting polymer resin 124 often depends on the physical and chemical characteristics of the porosity agents 150 and how these characteristics interact with the energy curable resin 124. Thus, it is understood that the critical pigment volume concentration of the energy curable resin 124 will vary across different porosity agents 150.

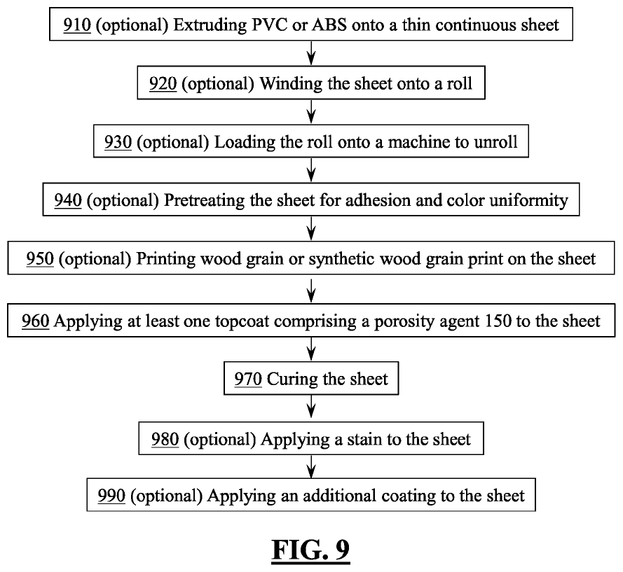

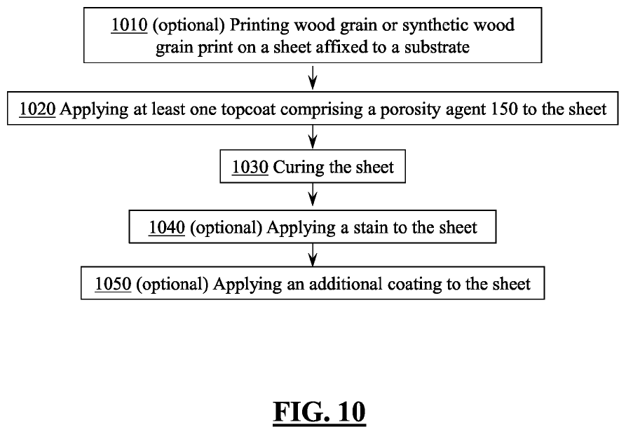

FIG. 9-10 depict non-limiting examples of manufacturing the stainable finish foil product. In some non-limiting embodiments, the methods comprise applying to the surface of the finish foil sheet, which may be, for example, a finish foil sheet, with a stainable topcoat layer comprising porosity agent 150 (960) followed by curing the finish foil sheet (970).

In other non-limiting embodiments, the process started with an extruding process, for example, extruding the PVC or ABS onto a thin continuous sheet (910). In some non-limiting implementations, the sheet is between 10 mm-2500 mm wide. The sheet is then wound onto a roll for secondary processing (920). Once the PVC or ABS has been successfully extruded and rolled, the roll is then loaded onto a machine to unroll (930) and pretreated for adhesion and color uniformity (940). Thereafter, ink is applied to the sheet (950). In certain non-limiting implementations, the ink is applied through either a rotogravure printing using UV-cured, solvent-based, or water-based inks. In other non-limiting implementations, the ink is applied with high-speed digital printing using UV cured inks. After printing with a wood grain or synthetic wood grain print, the product is then coated with one or more topcoats (960). In certain non-limiting implementations, a UV-cured topcoat or an air-cured topcoat is used. The sheet is then cured (970). Once the foil has all of the layers completed, the product can be embossed for a grain texture or simply re-wound onto a roll and cut to size per customer specifications.

In some non-limiting embodiments, the finish foil sheet is affixed onto a substrate before the application of the stainable topcoat layer. See, e.g., FIG. 10.

FIG. 11 illustrates the types of natural mineral streaking that occurs in wood to create the grain pattern in each species. This illustration demonstrates maple grain patterns including the mineral streaking/grain portion and the open softer wood portions to create the overall pattern on maple.

FIG. 12A illustrates the contact angle θ as the angle between the intersection of the liquid-solid interface and the liquid-vapor interface at the three-phase contact line.

FIG. 12B illustrates the interface between water and the stainable coating layers. When θ>90°, there is little to no wetting; but when θ<90°, there is partial wetting, and spontaneous and complete wetting when the surface tension solid (γsv) is larger than the surface tension liquid (γsl). Wetting agents are added to alter the contact angle to less than 90°, allowing wetting by water-based stains.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

1. A stainable finish foil material, comprising:
a finish foil sheet; and
a stainable topcoat layer applied and affixed to the finish foil sheet,
wherein the stainable topcoat layer comprises two coatings comprising:
a first coating with a high proportion of soft minerals and a pigment volume concentration (PVC) of above 35%, and
a second coating with a different blend of soft minerals than the first coating and a second pigment volume concentration (PVC2) of greater than 40%.

2. The stainable finish foil material of claim 1, wherein the stainable topcoat layer includes wetting agents sufficient to provide a contact angle θ where θ≤90°.

3. The stainable finish foil material of claim 1, additionally comprising a semitransparent pearl essence layer between the first and second coatings.

4. The stainable finish foil material of claim 1, additionally comprising one or more ink layers having a wood grain pattern on top of the second coating.

5. The stainable finish foil material of claim 1, wherein the finish foil material comprises a polyvinyl chloride (PVC) sheet, an acrylonitrile butadiene styrene (ABS) sheet, a polyethylene terephthalate (PET) sheet, or a paper sheet.

6. The stainable finish foil material of claim 1, wherein the soft minerals comprise one or more of calcium carbonate, crystalline silica, kaolin clay, and talc.

7. The stainable finish foil material of claim 1, the minerals of the second coating comprise one or more of calcium carbonate, crystalline silica, kaolin clay, and talc.

8. A stainable finish foil product comprising the stainable finish foil material of claim 1 affixed to a substrate.

9. The stainable finish foil product of claim 8, where the stainable finish foil material is affixed to the substrate using a hot glue process.

10. The stainable finish foil material of claim 8, wherein the stainable topcoat layer includes wetting agents sufficient to provide a contact angle θ where θ≤90°.

11. The stainable finish foil product of claim 8, wherein the finish foil material comprises a polyvinyl chloride (PVC) sheet, an acrylonitrile butadiene styrene (ABS) sheet, a polyethylene terephthalate (PET) sheet, or a paper sheet.

12. The stainable finish foil product of claim 8, additionally comprising one or more ink layers having a wood grain pattern on top of the second coating.

13. A method of manufacturing a stainable finish foil product, comprising
first applying to a finish foil sheet, a first topcoat coating with a high proportion of soft minerals and a pigment volume concentration (PVC) of above 35%, and
then applying a second topcoat coating with a different blend of soft minerals than the first topcoat and a second pigment volume concentration (PVC2) of greater than 40%.

14. The method of manufacturing a stainable finish foil product of claim 13, wherein at least one of the first topcoat coating and second topcoat coating include wetting agents sufficient to provide a contact angle θ where θ≤90°.

15. The method of claim 13, wherein the first topcoat and second topcoat are applied via a rolling coater.

16. The method of claim 14, wherein the second topcoat comprises an ink layer having a pattern associated with wood grain.

17. The method of claim 16, additionally comprising a semitransparent pearl essence layer between the first and second topcoat coatings.

18. The method of claim 16, wherein the finish foil sheet comprises a polyvinyl chloride (PVC) sheet, an acrylonitrile butadiene styrene (ABS) sheet, a polyethylene terephthalate (PET) sheet, or a paper sheet.

19. The method of claim 13, wherein the soft minerals of the first topcoat coating comprise one or more of calcium carbonate, crystalline silica, diatomaceous earth, kaolin clay, and talc.

20. The method of claim 13, wherein the soft minerals of the second topcoat coating comprise one or more of calcium carbonate, crystalline silica, kaolin clay, diatomaceous earth, and talc.
